(19) United States
(12) Patent Application Publication
(10) Pub. No.: US 2006/0088071 A1
(43) Pub. Date: Apr. 27, 2006

(54) Laser driver controller for safe operation of laser diode-based optical transmitters

(76) Inventor: Ka'ren Hovakimyan, Sunnyvale, CA (US)

Correspondence Address: COOLEY GODWARD, LLP, 3000 EL CAMINO REAL, 5 PALO ALTO SQUARE, PALO ALTO, CA, 94306, US

(21) Appl. No.: 11/255,599

(22) Filed: Oct. 20, 2005

Related U.S. Application Data
(60) Provisional application No. 60/621,191, filed on Oct. 21, 2004.

(51) Int. Cl. H01S 3/00; H01S 3/13

(52) U.S. Cl. 372/38.02; 372/29.021; 372/29.014

(57) ABSTRACT

A method, apparatus and system for controlling operation of a laser driver to limit emission levels of laser diodes each producing different monitor photocurrents are disclosed. In one embodiment, a laser driver controller includes a control signal generator configured to generate a single control signal to concurrently regulate an average power of the emission levels to a target average power level, and to generate a monitored output power reference to determine whether an output power of the emission levels exceeds an output power limit. The control signal generator can more accurately limit the emission levels than if the monitored output power reference is adjusted independent of regulating the average power.

### CROSS REFERENCE TO RELATED APPLICATION

This application claims the benefit of U.S. Provisional Application No. 60/621,191, entitled “Method of Interfacing of Laser Driver and Control Circuitry for Laser Safety Operation,” filed on Oct. 21, 2004, the contents of which are hereby incorporated by reference in their entirety.

### BRIEF DESCRIPTION OF THE INVENTION

This invention relates generally to laser devices for optical communications, and more particularly, to a laser driver controller configured to limit emission levels from laser devices, such as laser diodes.

### BACKGROUND OF THE INVENTION

Manufacturers of laser products generally include safety mechanisms so that the laser products comply with strict requirements for safe operation. Examples of laser products include laser diodes, which are commonly used in communication systems. The International Electrotechnical Commission (“IEC”) has set forth a standard that limits laser emission levels to safe levels for various classifications of laser products. The IEC 60825-1, 2^{nd} Amendment, which is a standard, provides for an emission limit of 10 mW for class 1 lasers for continuous modes of operation (i.e., within the 1400-4000 nm range of wavelengths). An example of a laser diode that is designed to comply with class 1 requirements is shown in FIG. 1.

FIG. 1 depicts a conventional configuration 100 adapted to control operation of a laser diode so that it operates within safe levels of operation. Configuration 100 includes a laser driver 102, a laser diode package (“#1”) 120, a shutdown switch 110, a monitor resistance (“Rmon”) 140 and an average power control resistance (“Rapc”) 142. Laser diode package (“#1”) 120 includes a laser diode 122 for generating laser light and a monitor photodiode (“PD”) 124 for generating a monitor photocurrent (“Ipc”) 132 representative of the laser output power of laser diode 122. Laser driver 102 includes a modulation/bias generator 130 for providing bias and modulation currents for driving laser diode 122. Laser driver 102 also includes an average power controller (“APC”) 106 and power detector 104. Average power controller 106 adjusts the laser bias current from modulation/bias generator 130 and hence the laser output power until monitor photocurrent (“Ipc”) 132 matches a reference current 134. Power detector 104 monitors a measured voltage (“Vmeas”) 138 that is indicative of the value of the output power of laser diode 122. Measured voltage 138 is generally proportional to monitor photocurrent (“Ipc”) 132. When power detector 104 detects that measured voltage 138 exceeds a value representing a limit for the output power, power detector 104 generates a fault signal (“TxFault”) 136 to initiate the shutdown of laser diode 122 by shutdown switch 110, which shuts down laser diode 122 to prevent it from operating beyond safe operational limits.

Average power control resistance 142 has an adjustable resistance that is set at a specific value for different values of monitor photocurrent, which in turn determines the average output power for laser diode 122. In some cases, average power control resistance 142 can be a potentiometer or can include a digital-to-analog converter with a resistor. Monitor resistance 140 is a resistor for setting Vmeas 138. A drawback to implementing monitor resistance 140 is that it generally has a fixed value and does not adapt to fluctuations in monitor photocurrents for different laser diodes and monitor photodiodes, both of which influence operation of laser diode packages. When the same monitor resistance 140 is used for different laser diode packages (#1) 120, monitor resistance 140 can cause laser diode 122 to operate in a noncompliant manner. For example, consider that laser diode package (“#1”) 120 is associated with a monitor photocurrent of 800 uA during normal average output power levels (e.g., 2 mW), whereas another laser diode package (“#2”) 123 has a monitor photocurrent of 150 uA for the same normal average output power levels. Consequently, laser diode (“#2”) generates lower values of monitor photocurrent. So if monitor resistance 140 is set for use with laser diode (“#1”) 122, then 4000 uA (e.g., 10 mW/2 mW*800 uA) is associated with the limit for shutting down operation of the laser. But if laser diode (“2”) 123 is substituted for laser diode (“#1”) 122, then it will reach a noncompliant limit (i.e., over 10 mW) at about 750 uA (e.g., 10 mW/2 mW*150 uA). Laser diode (“2”) 123 will continue to operate in a noncompliant manner until 4000 uA is reached, thereby potentially exposing humans to harmful effects of the emissions.

While traditional laser driver control mechanisms are functional, it would be desirable to minimize the drawbacks of conventional laser driver controllers to limit emission levels of various kinds of laser diodes that each produces a different monitor photocurrent.

### SUMMARY OF THE INVENTION

A method, apparatus and system for controlling operation of a laser driver to limit emission levels of laser diodes each producing different monitor photocurrents are disclosed. In one embodiment, a laser driver controller includes a control signal generator configured to generate a single control signal to concurrently regulate an average power of the emission levels to a target average power level, and to generate a monitored output power reference to determine whether an output power of the emission levels exceeds an output power limit. The control signal generator can more accurately limit the emission levels than if the monitored output power reference is adjusted independent of regulating the average power.

### BRIEF DESCRIPTION OF THE FIGURES

The invention is more fully appreciated in connection with the following detailed description taken in conjunction with the accompanying drawings, in which:

FIG. 1 depicts a conventional configuration adapted to control operation of a laser diode so that it operates within safe levels of operation;

FIG. 2 is a block diagram showing a laser driver controller for controlling emission levels of laser diodes that each produce different monitor photocurrents, according to one embodiment of the invention;

FIG. 3 is a block diagram depicting a laser driver controller for controlling a laser driver, according to a specific embodiment of the invention;

FIG. 4 illustrates the reduced laser output shutdown power for different laser samples using an implementation of the laser driver controller of FIG. 3, according to an embodiment of the invention;

FIG. 5 is a block diagram depicting another laser driver controller for controlling a laser driver, according to another specific embodiment of the invention;

FIG. 6 is a block diagram depicting yet another laser driver controller for controlling a laser driver, according to yet another specific embodiment of the invention; and

FIG. 7 is a block diagram an optical transmitter implementing a laser driver controller, according to a specific embodiment of the invention.

Like reference numerals refer to corresponding parts throughout the several views of the drawings. Note that most of the reference numerals include one or two left-most digits that generally identify the figure that first introduces that reference number.

### DETAILED DESCRIPTION OF EXEMPLARY EMBODIMENTS

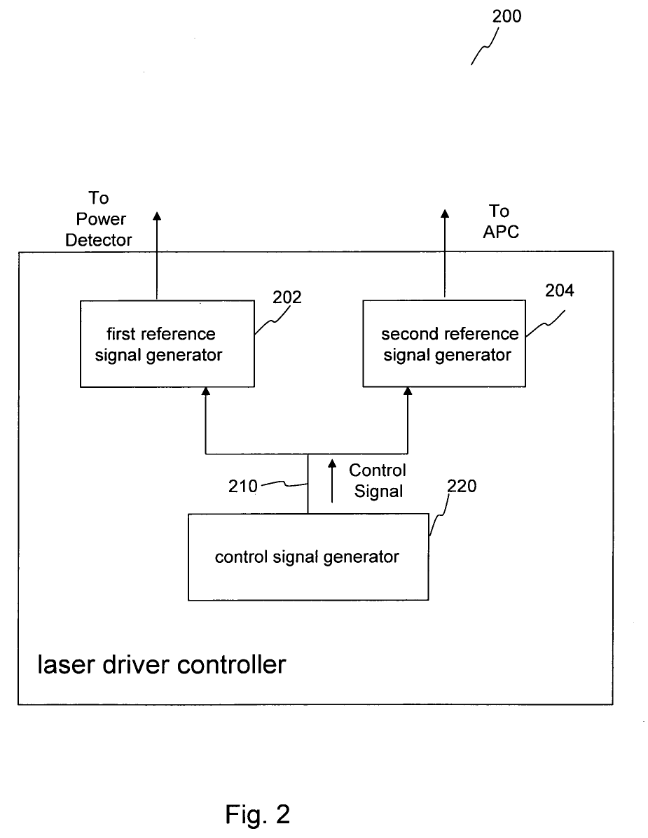

FIG. 2 is a block diagram showing a laser driver controller for controlling emission levels of laser diodes that each produces different monitor photocurrents, according to one embodiment of the invention. Laser driver controller 200 includes at least control signal generator 220 as well as a first reference signal generator 202 and a second reference signal generator 204. Control signal generator 220 is configured to generate a single control signal 210 to regulate the average power of the emissions from laser diodes to a target average power level, above which the laser diodes are generating emissions that are noncompliant with safety standards, such as IEC 60825-1, 2^{nd} Amendment. Control signal generator 220 is also configured to generate a monitored output power reference to determine whether an output power of the emission levels exceeds an output power limit. Notably, control signal generator 220 can adjust the monitored output power reference as a function of regulating the average power. Advantageously, control signal generator 220 can more accurately limit the emission levels than if the monitored output power reference is adjusted independent of regulating the average power, especially when the monitored output power reference is conventionally set by a resistance value that is used for many different laser diodes that generate a wide range of photocurrents. Further, control signal generator 220 advantageously conserves resources that otherwise are implemented to independently monitor the output power and regulate the average power, both of which conventionally require separate control signal generation means.

First reference signal generator 202 is configured to generate a first voltage level representative of the monitored output power reference based on control signal 210. In one instance, first reference signal generator 202 provides the first voltage level to a power detector (not shown) of a laser driver. Second reference signal generator 204 is configured to generate a second voltage level representative of the target average power level based on control signal 210. Second reference signal generator 204 provides the second voltage level to an average power controller (“APC”) (not shown) of the laser driver. In one embodiment, the first voltage level is a monitor voltage (“Vmon”) and the second voltage level is an average power controlling voltage (“Vapc”). In a specific embodiment, first reference signal generator 202 is a first resistor and second reference signal generator 204 is a second resistor.

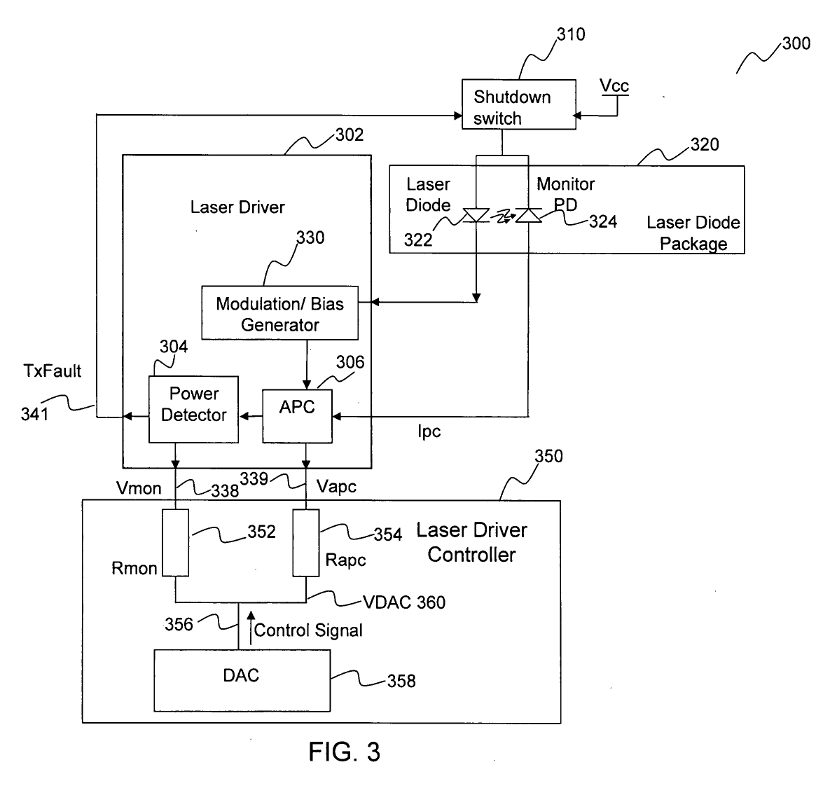

FIG. 3 is a block diagram depicting a laser driver controller for controlling a laser driver, according to a specific embodiment of the invention. Configuration 300 includes a laser driver 302, a shutdown switch 310, a laser diode package 320, and a laser driver controller 350. Laser driver 302 includes a modulation/bias generator 330 for providing bias and modulation currents for driving laser diode 322. Laser driver 302 also includes an average power controller (“APC”) 306 and a power detector 304. Average power controller (“APC”) 306 adjusts the laser bias current to change the laser output power with respect to an average power control voltage 339. Power detector 304 monitors a monitor voltage (“Vmon”) 338, which is indicative of the value of the monitored output power generated by laser diode 322. Laser diode package 320 includes laser diode 322 and a monitor photodiode (“PD”) 324 for generating a monitor photocurrent (“Ipc”) representative of the laser output power of laser diode 322. Note that the fluctuation in monitor photocurrent from sample to sample of laser diode package is generally due to the different operational characteristics of both laser diode 322 and a monitor photodiode (“PD”) 324.

In the example shown in FIG. 3, laser diode controller 350 includes a monitor resistance (“Rmon”) 352 and an average power control resistance (“Rapc”) 354 as a first reference signal and a second reference signal generator, respectively. Laser diode controller 350 also includes a single digital-to-analog converter (“DAC”) 358 as a control signal generator to form a voltage (“Vdac”) 360, which is applied to both (“Rmon”) 352 and an average power control resistance (“Rapc”) 354. In particular, laser diode controller 350 includes a single digital-to-analog converter (“DAC”) 358 to generate single control signal 356, which is used to generate Vmon 338 (using Rmon 352) and Vapc 339 (using Rapc 354). In operation, single control signal 356 is configured to adjust Vapc 339 to regulate the laser average power for any number of different laser samples, each of which is dependent on a specific monitor photocurrent coefficient (“Ipc_coeff”) expressed in units of uA/mW. The monitor photocurrent coefficient, Ipc_coeff, can have a wide range of values, such as from 75 uA/mW to 1000 uA/mW. Advantageously, single control signal 356 concurrently adjusts both Vapc 339 and Vmon 338. Adjusting Vapc 339 regulates the laser average power, whereas adjusting Vmon 338 sets the monitored output power reference. Power detector 304 compares Vmon 338 (i.e., the monitored output power reference) to a voltage representing an output power limit (“Vlim”). If Vmon 338 exceeds Vlim, then power detector 304 sends signal TxFault 341 to activate shutdown switch 310, thereby shutting down laser diode 322. An example of a laser driver that is suitable to practice the present invention is MAX3735A manufactured by Maxim, Inc.

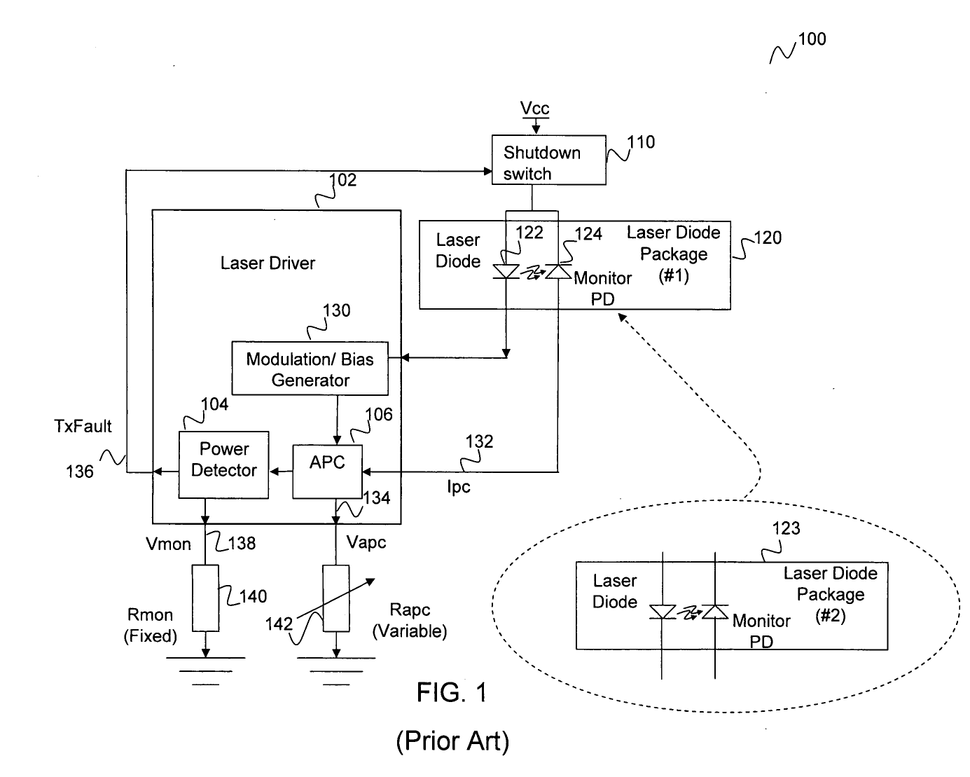

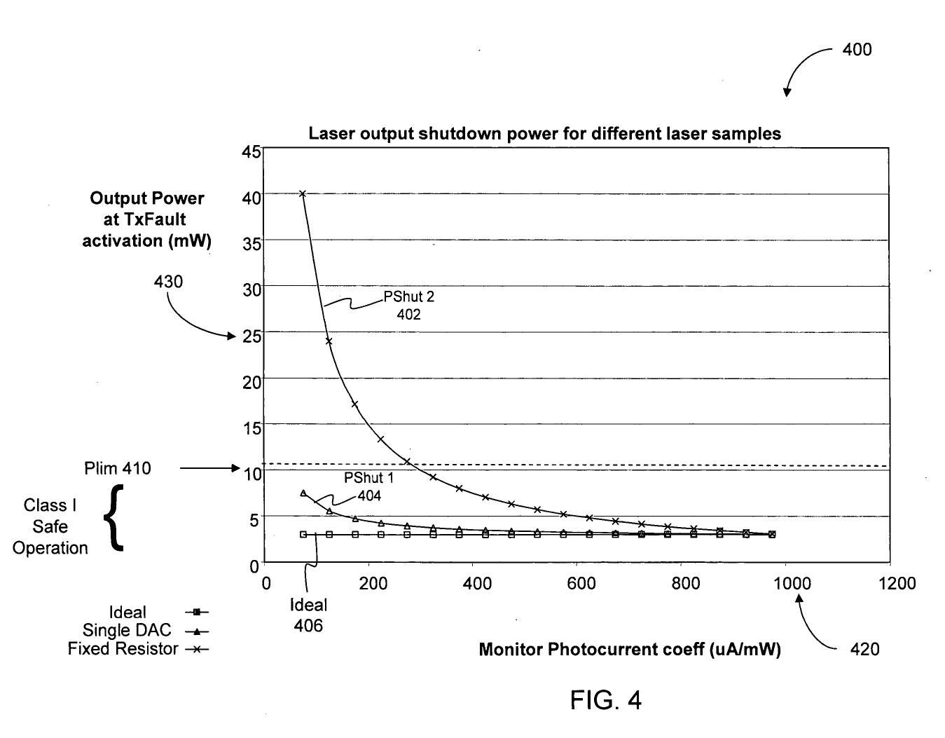

FIG. 4 illustrates the reduced laser output shutdown power for different laser samples using an implementation of the laser driver controller of FIG. 3, according to an embodiment of the invention. Graph 400 shows an ideal relationship 406 between different monitor photocurrent coefficients (uA/mW) normally encountered for different types of laser diodes and the output power 430 at TxFault activation (i.e., when Vmon is exceeded). Ideally, output power 430 should not significantly fluctuate about 3 mW, which is below the monitored output power limit (“Plim”) 410 of, for example, 10 mW. Monitored output power limit (“Plim”) 410 coincides with Vmon reaching and/or surpassing Vlim, which is a voltage representative of Plim 410. Curve (“PShut2”) 402 and curve (“PShut1”) 404 respectively depict output power levels 430 as a function of the various different monitor photocurrent coefficients 420, which gives rise to various values of monitor photocurrents. Curve 404 is representative of output power (i.e., laser emission) levels that are typical when implementing laser driver controller 350 of FIG. 3, whereas curve 402 is representative of output power levels that normally are encountered using the conventional technique of fixing Vmon (i.e., using a fixed Rmon resistance value), such as shown in FIG. 1. Advantageously, output power levels 430 of curve 404 remain below monitored output power limit (“Plim”) 410, unlike output power levels 430 of curve 402 developed by a laser driver (not shown) using a fixed Rmon resistance value. Some output power levels 430 exceed monitored output power limit (“Plim”) 410 when a fixed Rmon resistance value is used.

The following discussion describes one approach to substantiate the relationships depicted in FIG. 4. First, consider Equations (1) and (2):
Vmon=Vdac+Ipc*R1 (1)
Vapc−Vdac=(Ipc_{—}coeff*Pdes)*R2, (2)
where Vdac represents the voltage level applied to both Rmon and Rapc, and Pdes represents a desired output power setting. If the value for monitor photocurrent is Ipc, then Equation (3) determines the output power, Pout, as follows:
Pout=(Ipc/Ipc_{—}coeff) (3)
Next, consider the optimization of resistance values for Rmon and Rapc. The range of possible values for Vdac should be selected to provide the best resolution for a specific DAC. Values of Vdac should be in a range from 0 volts to Vapc. Zero volts corresponds to the maximum possible value of Ipc_coeff (“Ipc_coeff_max”). As such, Rapc can be set by the following: Rapc=Vapc/(Ipc_coeff_max*Pdes).

Next, Rmon is determined. Note that the minimum output power (“Pshut_min”) is a power level at which a fault condition arises, which necessitates shutting down the emissions from a laser diode. Also note that the value of Pshut_min should generally be less than Pdes. First, determination of Rmon begins with setting Vdac to 0 volts for Ipc_coeff equal to Ipc_coeff_max. Then, Rmon can be determined by the following: Rmon=Vlim/(Pshut_min*Ipc_coeff_max). Further, the laser output power at the instance that the laser is shutdown occurs when Pout equals Pshut (i.e., Vmon equals Vlim), where Pout can be derived from Equations (1) to (3). Equation 4 determines the laser output power for a laser controlled using the laser driver controller of the various embodiments.
Pshut1=(Vlim−Vapc+Ipc_{—}coeff*Pdes*R2)/(Ipc_{—}coef*R1) (4)
But note that for a fixed resistor-based laser driver controller, the laser output power at the moment the laser shuts down can be derived from Equations (1) and (3), assuming Vdac=0 in (1). Equation 5 determines the laser output power for a laser controlled using fixed-resistances in controlling conventional laser drivers.
Pshut2=Vlim/(R1*Ipc_{—}coeff) (5)

For illustrative purposes, consider that Pdes is set to 2 mW and the shutdown activation point (“Pshut_min”) is set to be not less then 3 mW, which allows a 1 mW margin from a normal operation point of 2 mW. Further, set Vlim at 1.4 volts and Vapc at 23 volts. Given these values, curve (“Pshut2”) 402 of FIG. 4 indicates that conventional laser driver control techniques that include a fixed Rmon resistor cannot adequately deal with wide range of different lasers' monitor photocurrent coefficients. As such, the shutdown laser power may vary from 3 mW to 40 mW. Given the above values, the single DAC approach advantageously provides a narrower range of output shutdown powers below class 1 laser limits, such as in a narrower range from 3 mW to 7.5 mW.

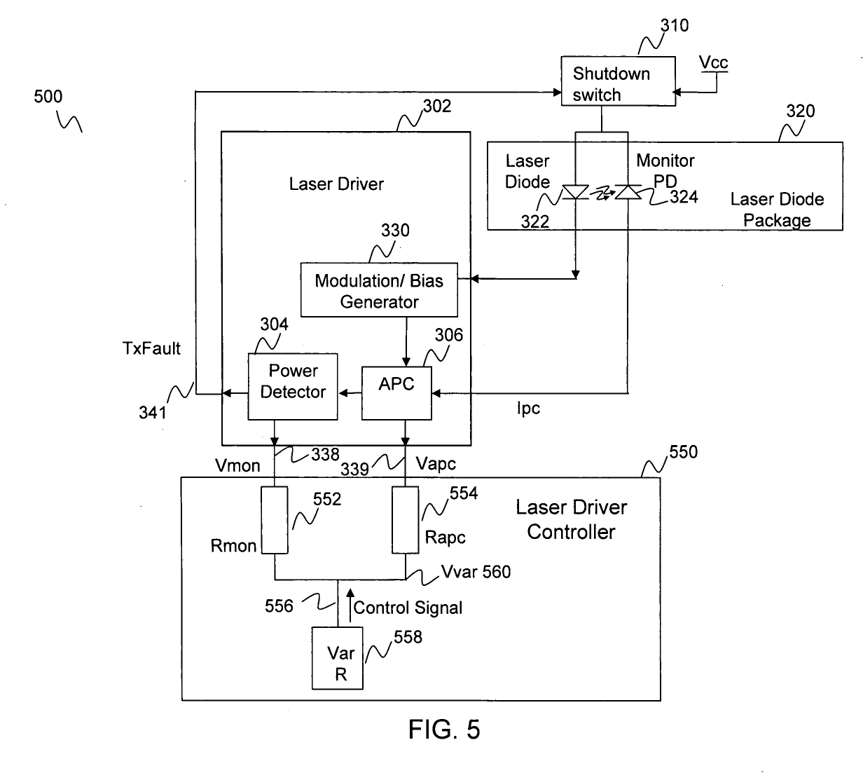

FIG. 5 is a block diagram depicting another laser driver controller for controlling a laser driver, according to another specific embodiment of the invention. Configuration 500 includes a laser driver 302, a shutdown switch 310, and a laser diode package 320, all of which includes structures and/or functionalities described above, such as in FIG. 3. Configuration 500 also includes laser driver controller 550, which includes a monitor resistance (“Rmon”) 552 and an average power control resistance (“Rapc”) 554 as a first reference signal and a second reference signal generator, respectively. Laser diode controller 550 also includes a single variable resistor (“Var R”) 558 as a control signal generator to use control signal 556 to form a variable resistance-based voltage (“Vvar”) 560, which is applied to both (“Rmon”) 552 and an average power control resistance (“Rapc”) 554. In various embodiments, single variable resistor (“Var R”) 558 can be either a digital potentiometer or a variable resistor to provide the advantages similarly set forth by laser driver controller 350 of FIG. 3.

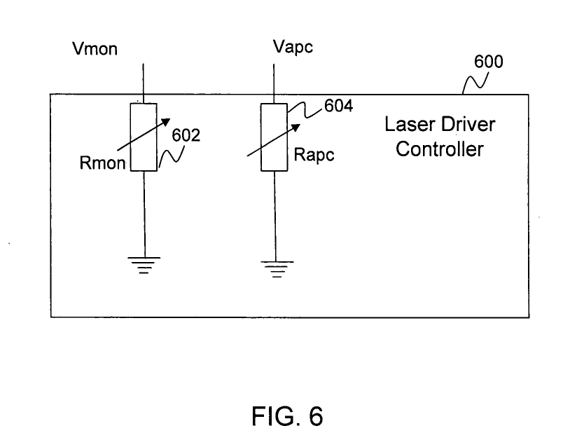

FIG. 6 is a block diagram depicting yet another laser driver controller for controlling a laser driver, according to yet another specific embodiment of the invention. Laser driver controller 600 includes Rmon 602 and Rapc 604, both of which are variable resistors for monitoring output power levels and setting an average power for a laser diode. An adjustable Rmon 602 facilitates adjusting the monitored output power reference used to operate lasers in safe ranges of emissions.

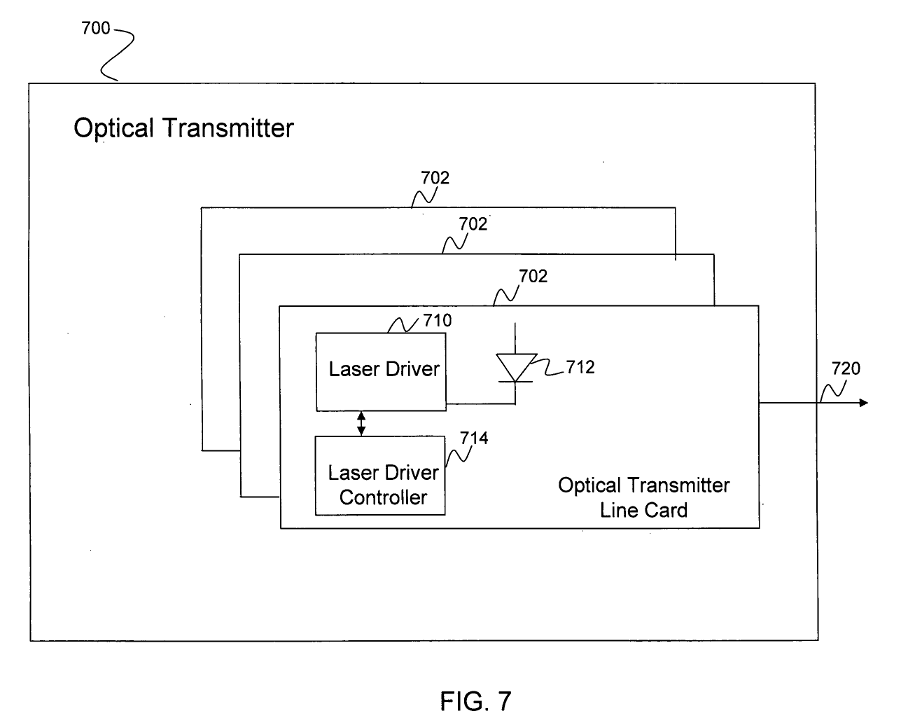

FIG. 7 is a block diagram of an optical transmitter implementing a laser driver controller, according to a specific embodiment of the invention. Optical transmitter 700 includes any number of optical transmitter line cards 702 for producing optical data signals 720 for transit over an optical network. Each optical transmitter line cards 702 includes a laser driver 710, a laser diode 712 and a laser driver controller 714 in accordance with an embodiment of the invention. A suitable optical transmitter, according to at least one embodiment, is the AT-LX3800U 8-slot Multi-service chassis implementing AT-LX3811 Multi-rate line cards, both of which are manufactured by Allied Telesyn, Inc. of Bothell, Wash., USA.

The foregoing description, for purposes of explanation, used specific nomenclature to provide a thorough understanding of the invention. However, it will be apparent to one skilled in the art that specific details are not required in order to practice the invention. In fact, this description should not be read to limit any feature or aspect of the present invention to any embodiment; rather features and aspects of one embodiment may readily be interchanged with other embodiments. For example, although the above description of the embodiments related to a laser and to a laser driver for optical communications, the discussion is applicable to other applications.

Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. Notably, not every benefit described herein need be realized by each embodiment of the present invention; rather any specific embodiment can provide one or more of the advantages discussed above. It is intended that the following claims and their equivalents define the scope of the invention.

1. A laser driver controller for controlling operation of a laser driver to limit emission levels of laser diodes each producing different monitor photocurrents, said laser driver controller comprising:
a control signal generator configured to generate a single control signal to concurrently
regulate average power of said emission levels to a target average power level, and to
generate a monitored output power reference to determine whether an output power of said emission levels exceeds an output power limit.

2. The laser driver controller of claim 1 wherein said control signal generator is further configured to adjust said monitored output power reference as a function of regulating said average power, thereby more accurately limiting said emission levels than if said monitored output power reference is set independent of regulating said average power.

3. The laser driver controller of claim 2 wherein said control signal generator conserves resources that otherwise are implemented to independently monitor said output power and regulate said average power.

4. The laser driver controller of claim 2 further comprising:
a first reference signal generator configured to generate a first voltage level representative of said monitored output power reference based on said control signal; and
a second reference signal generator configured to generate a second voltage level representative of said target average power level based on said control signal.

5. The laser driver controller of claim 4 wherein first voltage level is a monitor voltage (“Vmon”) and said second voltage level is an average power controlling voltage (“Vapc”) and a limit voltage (“Vlim”) is representative of said output power limit.

6. The laser driver controller of claim 4 wherein said first reference signal generator is a first resistor and said second reference signal generator is a second resistor.

7. The laser driver controller of claim 4 wherein said control signal generator is either a digital or a mechanical potentiometer.

8. The laser driver controller of claim 4 wherein said control signal generator is a digital-to-analog converter (“DAC”).

9. A method for controlling operation of a laser diode to limit emission levels, said method comprising:
setting a target average power level from a first power level to a second power level; and
adjusting a monitored output power reference by an amount proportional to setting said target average power level from said first power level to said second power level, said monitored output power reference being adjusted simultaneous to setting said target average power level,
wherein said amount is a function of an operating characteristic of said laser diode.

10. The method of claim 9 wherein said operating characteristic is a monitor photocurrent.

11. The method of claim 9 wherein said setting a target average power level comprises changing a magnitude of a single control signal that both sets said target average power level and adjusts said monitored output power reference.

12. The method of claim 111 further comprising:
regulating an average power of said emission levels to said target average power level; and
monitoring an output power of said emission levels as monitored output power.

13. The method of claim 12 further comprising:
comparing a monitor voltage (“Vmon”) indicative of said monitored output power reference to a limit voltage (“Vlim”) indicative of an output power limit; and
shutting down said laser diode in response to said monitor voltage violating said limit voltage.

14. An optical transmitter configured to generate optical communications signals comprising:
a plurality of laser diodes configured to generate said optical signals;
a plurality of laser drivers for driving said laser diodes; and
a plurality of laser driver controllers, each including:
a control signal generator configured to generate a control signal,
a first reference signal generator configured to generate a monitor voltage (“Vmon”) representative of a monitored output power reference, and
a second reference signal generator configured to generate an average power controlling voltage (“Vapc”) representative of a target average power level,
wherein said control signal determines both said monitored output power reference and said target average power level.

15. The optical transmitter of claim 14 wherein said control signal generator is configured to determines a value for said monitor voltage as a function of a photocurrent of one of said laser diodes.

16. The optical transmitter of claim 14 wherein said control signal generator is either a digital or a mechanical potentiometer.

17. The optical transmitter of claim 14 wherein said control signal generator is a digital-to-analog converter (“DAC”).

18. The optical transmitter of claim 14 further comprising:
a line card including
at least one of said plurality of laser diodes,
at least one of said plurality of laser drivers, and
at least one of said laser driver controllers.
